(19) United States
(12) Patent Application Publication
(10) Pub. No.: US 2026/0022309 A1
(43) Pub. Date: Jan. 22, 2026

(54) COMPOSITIONS AND METHODS OF USE FOR EQUIPMENT DEGREASING

(71) Applicant: ECOLAB USA INC., Saint Paul, MN (US)

(72) Inventors: Haoran Li, SHANGHAI (CN); Huarong Yu, Shanghai (CN)

(21) Appl. No.: 18/997,315

(22) PCT Filed: Aug. 9, 2022
(86) PCT No.: PCT/CN2022/111088

§ 371 Date: Jan. 21, 2025

(51) Int. Cl. C11D 3/04; C11D 1/14; C11D 1/22; C11D 1/66; C11D 1/72; C11D 3/08; C11D 3/10; C11D 3/33; C11D 9/12; C11D 9/30; C11D 17/00

(52) U.S. Cl. CPC C11D 3/044; C11D 1/143; C11D 1/146; C11D 1/22; C11D 1/662; C11D 1/72; C11D 3/08; C11D 3/10; C11D 3/33; C11D 9/12; C11D 9/30; C11D 17/0073; C11D 2111/16

(57) ABSTRACT

Solid cleaning and degreasing compositions and methods of using the same for various hard surfaces and equipment degreasing are provided. The solid cleaning and degreasing compositions include at least two alkalinity sources, a chelant, and a surfactant providing degreasing efficacy that penetrates soils and efficient processing for solids. The compositions are particularly well suited for cleaning and degreasing efficacy for soil removal of baked on, greasy soils, including those found in ovens.

### TECHNICAL FIELD

The disclosure relates generally to compositions and methods of using the same for equipment degreasing. The present disclosure provides compositions having at least two alkalinity sources, a chelant, and a surfactant providing degreasing efficacy that penetrates soils and efficient processing for solids, including pressed tablets, that can be used for cleaning and degreasing various types of equipment, namely those in food preparation and/or processing. The compositions are particularly well suited for cleaning and degreasing efficacy for soil removal of baked on, greasy soils, including those found in ovens.

### BACKGROUND

Aqueous cleaning compositions are commonly used in most cleaning applications. Most liquid materials even in a concentrate form contain substantial amounts of water which can be difficult to manufacture, transport and sell. Although many liquid formulations have had commercial success, there remains a need to manufacture solid compositions to provide excellent soil, e.g. grease, removal properties. Solid formulations have unique advantages over conventional liquids, granules, or pellet forms of cleaning compositions, including improved handling, enhanced safety, elimination of component segregation during transportation and storage, and increased concentrations of active components within the composition. Because of these advantages, solids are desired for use in commercial and institutional entities that routinely use large quantities of cleaning materials, as well as consumer use applications.

Although various compositions and methods to produce solid cleaning compositions are known, there remains a need to provide highly concentrated alkaline solids that provide at least equivalent cleaning efficacy as liquid products. There further remains a need to formulate solid cleaning compositions that do not create residues, leave films, etc. on the treated surfaces and/or equipment used to produce the solid cleaning compositions.

Another need in the formulation of solid cleaning compositions is to provide compositions without phosphates. The phosphates typically serve multiple purposes including for example, to control the rate of solidification, to remove and suspend soils, and as an effective hardness sequestrant. However, due to ecological and other concerns, the replacement of phosphorous-containing compounds, along with nitrilotriacetic acid (NTA)-containing components is also a priority. Accordingly, another focus of the disclosure is to develop solid cleaning compositions that do not contain phosphonates and/or NTA.

It is a further object of this disclosure to provide solid cleaning composition that are high alkaline formulations for use in cleaning systems, equipment, etc., including automatic cleaning systems.

It is a further object of the disclosure to provide solid cleaning composition to efficiently clean and degrease surfaces subject to baked on, greasy soils.

It is another object of this disclosure to provide solid cleaning composition to efficiently clean and degrease surfaces without create residues and/or leaving films.

Other objects, embodiments and advantages of this disclosure will be apparent to one skilled in the art in view of the following disclosure, the drawings, and the appended claims.

### BRIEF SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part. It is a primary object, feature, and/or advantage of the present disclosure to improve on or overcome the deficiencies in the art in providing efficient cleaning and degreasing compositions for use in cleaning systems, equipment, etc., including automatic cleaning systems.

According to some aspects of the present disclosure, solid cleaning compositions comprise: at least two alkali metal alkalinity sources comprising an alkali metal hydroxide, alkali metal carbonate, alkali metal metasilicate, or combinations thereof; a chelant comprising an aminocarboxylic acid or salt thereof; and a surfactant comprising a salt of fatty acid, alkyl sulfate, alkyl ether sulfonate, alkyl aryl sulfonate, alkyl benzene sulfonate; alkyl polyglucoside, fatty alcohol polyether, or combination thereof. In embodiments, the at least two alkali metal alkalinity sources comprise from about 50-90 wt-% of the composition, the at least one chelant comprise from about 1-10 wt-% of the composition, and the surfactant comprises comprise from about 0.5-5 wt-% of the composition.

According to some additional aspects of the present disclosure, methods of cleaning a hard surface comprise: providing a solid cleaning composition as described herein to a hard surface or object in need of cleaning; generating a use solution of the solid cleaning composition on the hard surface or in contact with the object in need of cleaning; and cleaning soils from the hard surface or object.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

FIG. 1 shows a photographic image of cleaning efficacy of solid compositions evaluated based on alkalinity concentration as described in Example 1.

FIG. 2 shows a photographic image of comparative cleaning performance of the solid cleaning and degreasing composition compared to a commercial alternative as described in Example 2.

Various embodiments of the present disclosure will be described in detail with reference to the drawings, wherein like reference numerals represent like parts throughout the several views. Reference to various embodiments does not limit the scope of the disclosure. Figures represented herein are not limitations to the various embodiments according to the disclosure and are presented for exemplary illustration of the invention. An artisan of ordinary skill in the art need not view, within isolated figure(s), the near infinite number of distinct permutations of features described in the following detailed description to facilitate an understanding of the present invention.

### DETAILED DESCRIPTION

The present disclosure is not to be limited to that described herein, which can vary and are understood by skilled artisans. No features shown or described are essential to permit basic operation of the present disclosure unless otherwise indicated. It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The methods and compositions of the present disclosure may comprise, consist essentially of, or consist of the components and ingredients of the present disclosure as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

Unless defined otherwise, all technical and scientific terms used above have the same meaning as commonly understood by one of ordinary skill in the art to which embodiments of the present disclosure pertain.

The term “invention” is not intended to refer to any single embodiment of the particular invention but encompass all possible embodiments as described in the specification and the claims.

The term “about,” as used herein, refers to variation in the numerical quantity that can occur, for example, through typical measuring techniques and equipment, with respect to any quantifiable variable, including, but not limited to, mass, volume, time, temperature, pH, and the like. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

As used herein, the term “cleaning” refers to a method used to facilitate or aid in soil removal, bleaching, microbial population reduction, and any combination thereof.

The terms “dimensional stability” and “dimensionally stable” as used herein, refer to a solid product having a growth exponent of less than about 3%. If the solid product swells after solidification, various problems may occur, including but not limited to decreased density, integrity, and appearance; and inability to dispense or package the solid product. Generally, a solid product is considered to have dimensional stability if the solid product has a growth exponent of less than about 3%. Growth exponent refers to the percent growth or swelling of a product over a period of time after solidification under normal transport/storage conditions. Because normal transport/storage conditions for detergent products often results in the detergent composition being subjected to an elevated temperature, the growth exponent of a solid detergent product may be determined by measuring one or more dimensions of the product prior to and after heating at between about 100° F. and 122° F. at 75% relative humidity. The measured dimension or dimensions depends on the shape of the solid product and the manner in which it swells. For tablets, the change in both diameter and height is generally measured and added together to determine the growth exponent. For capsules, just the diameter is normally measured.

As used herein, the term “exemplary” refers to an example, an instance, or an illustration, and does not indicate a most preferred embodiment unless otherwise stated.

As used herein, the phrase “food processing surface” refers to a surface of a tool, a machine, equipment, a structure, a building, or the like that is employed as part of a food processing, preparation, or storage activity. Examples of food processing surfaces include surfaces of food processing or preparation equipment (e.g., slicing, canning, or transport equipment, including flumes), of food processing wares (e.g., utensils, dishware, wash ware, and bar glasses), and of floors, walls, or fixtures of structures in which food processing occurs. Food processing surfaces are found and employed in food anti-spoilage air circulation systems, aseptic packaging sanitizing, food refrigeration and cooler cleaners and sanitizers, ware washing sanitizing, blancher cleaning and sanitizing, food packaging materials, cutting board additives, third-sink sanitizing, beverage chillers and warmers, meat chilling or scalding waters, autodish sanitizers, sanitizing gels, cooling towers, food processing antimicrobial garment sprays, and non-to-low-aqueous food preparation lubricants, oils, and rinse additives.

As used herein, the term “free” refers to compositions completely lacking the component or having such a small amount of the component that the component does not affect the performance of the composition. The component may be present as an impurity or as a contaminant and shall be less than about 0.1 wt-%, less than about 0.01 wt-%, or free of the component.

The term “generally” encompasses both “about” and “substantially.”

The term “hard surface” refers to a solid, substantially non-flexible surface such as an appliance, machinery, and the like. Hard surfaces are not limited by the material; for example, a hard surface can be glass, metal, tile, vinyl, linoleum, composite, wood, plastic, etc., although many hard surfaces which are cleaned and degreased according to the methods described herein are predominantly metal. Hard surfaces may include for example, food processing surfaces.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x”mers, further including their analogs, derivatives, combinations, and blends thereof. Furthermore, unless otherwise specifically limited, the term “polymer”shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

As used herein, the term “soil” or “stain” refers to any soil, including, but not limited to, non-polar oily and/or hydrophobic substances which may or may not contain particulate matter such as industrial soils, mineral clays, sand, natural mineral matter, carbon black, graphite, kaolin, environmental dust, and/or food based soils such as blood, proteinaceous soils, starchy soils, fatty soils, cellulosic soils, etc. The compositions and methods described herein are particularly well suited for cleaning greasy soils.

It should be understood that the term “solid” refers to the state of the composition under the expected conditions of storage and use of the solid composition. In general, it is expected that a solid composition will remain a solid at a temperature up to about 120° F. while retaining dimensional stability.

The term “substantially” refers to a great or significant extent. “Substantially” can thus refer to a plurality, majority, and/or a supermajority of said quantifiable variable, given proper context.

As used herein, the term “substantially free” refers to compositions completely lacking the component or having such a small amount of the component that the component does not affect the performance of the composition. The component may be present as an impurity or as a contaminant and shall be less than about 0.5 wt-%. In another embodiment, the amount of the component is less than about 0.1 wt-% and in yet another embodiment, the amount of component is less than about 0.01 wt-%.

The term “surfactant” or “surface active agent” refers to an organic chemical that when added to a liquid changes the properties of that liquid at a surface.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

### Solid Cleaning and Degreasing Compositions

According to embodiments, the solid cleaning and degreasing compositions include at least two alkali metal alkalinity sources, a chelant, and a surfactant. According to further embodiments, the solid cleaning and degreasing compositions include at least two alkali metal alkalinity sources comprising an alkali metal hydroxide, alkali metal carbonate, alkali metal metasilicate, or combinations thereof, a chelant comprising an aminocarboxylic acid or salt thereof, and a surfactant comprising a salt of fatty acid, alkyl sulfate, alkyl ether sulfonate, alkyl aryl sulfonate, alkyl benzene sulfonate; alkyl polyglucoside, fatty alcohol polyether, or combination thereof. The solid cleaning and degreasing compositions can include additional functional ingredients and are provided as concentrate solid compositions.

Exemplary solid cleaning and degreasing compositions are shown in Table 1 in weight percentages. While the components may have a percent actives of 100%, it is noted that Table 1 does not recite the percent actives of the components, but rather, recites the total weight percentage of the raw materials (i.e. active concentration plus inert ingredients).

TABLE 1

| | First | Second | Third |
|---|---|---|---|
| | Exemplary | Exemplary | Exemplary |
| Material | Range wt.-% | Range wt.-% | Range wt.-% |
| Alkali metal | 40-90 | 50-90 | 60-90 |
| alkalinity source(s) | | | |
| Chelant | 1-20 | 1-10 | 2-10 |
| Surfactant | 0.1-10 | 0.5-10 | 0.5-5 |
| Additional Functional | 0-40 | 0-20 | 0-15 |
| Ingredients | | | |

The solid cleaning and degreasing compositions are solid compositions, preferably solid tablets or blocks. In some embodiments, the solid is a pressed, cast, or extruded solid. The solids can include solid tablet, block, molded or formed solid pellet, block, tablet, powder, granule or flakes. In preferred embodiments, the solid is a pressed tablet or block.

The various embodiments of the solid cleaning and degreasing compositions provide a homogenous mixture of the components of the composition. The compositions do not require or include a multi-phased or multi-layered solid, therefore, providing ease in formulation and consistent disintegration and formulation of a homogenous use solution.

The solid cleaning and degreasing compositions are substantially homogeneous with regard to the distribution of ingredients throughout its mass and is dimensionally stable. The solid cleaning and degreasing compositions are hardened compositions that will not flow and will substantially retain its shape under moderate stress or pressure or mere gravity. The degree of hardness of the solid cleaning and degreasing composition may range from that of a fused solid block which is relatively dense and hard, for example, like concrete, to a consistency characterized as being a hardened paste.

In addition, the term “solid” refers to the state of the solid hard surface cleaning composition under the expected conditions of storage and use. In general, it is expected that the solid hard surface cleaning composition will remain in solid form when exposed to temperatures of up to about 40° C./100° F. and at about 75% relative humidity. The solids are dimensionally stable, meaning the solids do not swell (or change in dimension due to swelling), this is measured according to dimensional integrity of the solid and the maintained hardness (e.g. breakage, cracking, swelling), one way to assess is to measure the swelling of less than about 5%, or less than about 4% at temperatures of up to 40°° C. (or 100° F.) for at least 8 weeks. Such solids are referred to as dimensionally stable.

In various embodiments, the solid cleaning and degreasing compositions do not include solid gels.

The solid cleaning and degreasing compositions are preferably provided as a pressed solid tablet or block. A solid block can be provided in the form of a unit dose or a multi-use solid. A unit dose refers to a solid composition unit sized so that the entire unit is used during a single washing cycle. When the solid composition is provided as a unit dose it may have a size between about 1 gram and about 1,000 grams. Alternatively, a solid tablet may have a size of between about 1 gram and about 250 grams, namely from about 30 grams to about 100 grams. Further in some embodiments the solid tablets are individually packaged.

The solid cleaning and degreasing compositions are preferably substantially free of or free of phosphorous and/or NTA, making the compositions particularly useful in cleaning applications where it is desired to use an environmentally friendly, solid alkaline composition. Phosphorus-free means a solid composition having less than approximately 0.5 wt-%, less than approximately 0.1 wt-%, less than approximately 0.01 wt-% phosphorous. NTA-free means a solid composition having less than approximately 0.5 wt-%, less than approximately 0.1 wt-%, than approximately 0.01 wt-% NTA.

In preferred embodiments, the solid cleaning and degreasing compositions do not include specially fabricated nanoparticles.

### Alkalinity Sources

The solid cleaning and degreasing compositions comprise at least two alkali metal alkalinity sources. The solid cleaning and degreasing compositions comprise at least two alkali metal alkalinity sources comprising an alkali metal hydroxide, alkali metal carbonate, alkali metal metasilicate, or combinations thereof. In general, an effective amount of the alkalinity sources should be considered as an amount that provides a use solution having a pH of at least about 10, or preferably from about 10 to about 13.5. In general, it is desirable to provide the use solution as a highly alkaline cleaning composition having a pH above 10, above 11, above 12, or preferably from about 10 to about 13.5.

Exemplary alkalinity sources include alkali metal hydroxides, alkali metal carbonates, alkali metal silicates or metasilicates, and combinations thereof. Suitable alkali metal hydroxides that can be used include, for example, sodium, lithium, or potassium hydroxide. Suitable alkali metal carbonates that can be used include, for example, the hydratable salts sodium or potassium carbonate, bicarbonate, sesquicarbonate, or a mixture thereof. Suitable alkali metal silicates or metasilicates that can be used include, for example, the hydratable salts sodium or potassium silicate or metasilicate.

In some embodiments, at least two alkalinity sources are included in the solid cleaning and degreasing compositions comprising an alkali metal hydroxide, alkali metal carbonate, and/or alkali metal silicate or metasilicate. In further embodiments, at least three alkalinity sources are included in the solid cleaning and degreasing compositions comprising an alkali metal hydroxide, alkali metal carbonate, and alkali metal silicate or metasilicate.

In some embodiments, at least two alkalinity sources are included in the solid cleaning and degreasing compositions comprising sodium hydroxide, sodium carbonate, and/or sodium silicate or metasilicate. In further embodiments, at least three alkalinity sources are included in the solid cleaning and degreasing compositions comprising sodium hydroxide, sodium carbonate, and sodium silicate or metasilicate, preferably sodium metasilicate. In embodiments the alkalinity sources are provided as solids.

In some embodiments, the alkalinity sources are included in the solid cleaning and degreasing compositions at an amount of at least about 40 wt-% to about 90 wt-%, about 50 wt-% to about 90 wt-%, about 60 wt-% to about 90 wt-%, about 70 wt-% to about 90 wt-%, about 75 wt-% to about 90 wt-%, or about 80 wt-% to about 90 wt-%. In addition, without being limited according to the disclosure, all ranges recited are inclusive of the numbers defining the range and include each integer within the defined range.

In some embodiments, the alkalinity sources are included in the solid cleaning and degreasing compositions at an amount of the following alkalinity sources: (A) at least about 40 wt-% to about 80 wt-%, about 50 wt-% to about 80 wt-%, about 50 wt-% to about 75 wt-%, or about 55 wt-% to about 70 wt-% of alkali metal hydroxide, (B) at least about 5 wt-% to about 20 wt-%, about 5 wt-% to about 15 wt-%, about 7.5 wt-% to about 15 wt-%, or about 10 wt-% to about 15 wt-% of alkali metal carbonate, and (C) at least about 5 wt-% to about 20 wt-%, about 5 wt-% to about 15 wt-%, about 5 wt-% to about 12 wt-%, or about 5 wt-% to about 10 wt-% of alkali metal silicate or metasilicate. In addition, without being limited according to the disclosure, all ranges recited are inclusive of the numbers defining the range and include each integer within the defined range.

### Chelant

The solid cleaning and degreasing compositions comprise a chelant. In embodiments the chelant comprises an aminocarboxylic acid or salt thereof or an aminocarboxylate.

As referred to herein, aminocarboxylic acid or salts thereof in referring to chelants can be referred to as aminocarboxylates and can include materials containing little or no NTA. Exemplary aminocarboxylates include, for example, N-hydroxyethylaminodiacetic acid or salt thereof, ethylenediaminetetraacetic acid or salt thereof (EDTA), methylglycinediacetic acid or salt thereof (MGDA), hydroxyethylenediaminetetraacetic acid or salt thereof, diethylenetriaminepentaacetic acid or salt thereof, N-hydroxyethyl-ethylenediaminetriacetic acid or salt thereof (HEDTA), glutamic acid N,N-diacetic acid or salt thereof (GLDA), diethylenetriaminepentaacetic acid or salt thereof (DTPA), iminodisuccinic acid or salt thereof (IDS), ethylenediamine disuccinic acid or salt thereof (EDDS), 3-hydroxy-2,2-iminodisuccinic acid or salt thereof (HIDS), hydroxyethyliminodiacetic acid or salt thereof (HEIDA) and other similar acids (or salts thereof) having an amino group with a carboxylic acid (or salt thereof) substituent. In an embodiment, the aminocarboxylate is ethylenediaminetetraacetic acid or salt thereof (EDTA).

In some embodiments the solid cleaning and degreasing compositions do not include polyepoxysuccinic acids or salts thereof.

In some embodiments, the chelant included in the solid cleaning and degreasing compositions at an amount of at least about 1 wt-% to about 20 wt-%, about 1 wt-% to about 10 wt-%, about 1 wt-% to about 8 wt-%, or about 1 wt-% to about 6 wt-%. In addition, without being limited according to the disclosure, all ranges recited are inclusive of the numbers defining the range and include each integer within the defined range.

### Surfactant

The solid cleaning and degreasing compositions comprise a surfactant. In some embodiments, the surfactant is an anionic and/or nonionic surfactant.

In some embodiments, the surfactant is a salt of fatty acid, alkyl sulfate, alkyl ether sulfonate, alkyl aryl sulfonate, alkyl benzene sulfonate; alkyl polyglucoside, fatty alcohol polyether, or combination thereof.

In some embodiments, the surfactant has a C9-C20 carbon chain that can be linear or branched, and wherein the fatty alcohol polyether surfactant has 3 to 8 moles of ethylene oxide. In preferred embodiments, the surfactant is a sodium dodecylbenzene sulfonate, sodium dodecyl sulfate, sodium lauryl sulfate, sodium myristate sulfate, sodium alpha-olefin sulfonate, sodium palmitate, palmitoleic acid sodium salt, sodium myristate, sodium laurate, linoleic acid sodium salt, tetradecenoic acid sodium salt, lauroleic acid sodium salt, sodium oleate, C8-C10 polyglucoside, C12-C14 polyglucoside, fatty alcohol polyether, or combination thereof.

Beneficially and without being limited to a particular mechanism of action, the inclusion of an anionic surfactant, namely an alkali metal fatty acid salt, provides a processing aid benefit along with soil removal efficacy.

In some embodiments, the surfactant is included in the solid cleaning and degreasing compositions at an amount of at least about 0.1 wt-% to about 10 wt-%, about 0.5 wt-% to about 10 wt-%, about 1 wt-% to about 10 wt-%, or about 1 wt-% to about 5 wt-%. In addition, without being limited according to the disclosure, all ranges recited are inclusive of the numbers defining the range and include each integer within the defined range.

In some embodiments, the solid cleaning and degreasing compositions do not include additional surfactants. In some embodiments, the solid cleaning and degreasing compositions do not include alkyl glucosides and/or sodium lauryl sulfate.

### Additional Functional Ingredients

The components of the solid cleaning and degreasing compositions can further be combined with various functional components suitable for uses disclosed herein In some embodiments, the solid cleaning and degreasing compositions including the at least two alkali metal alkalinity sources, a chelant, a surfactant, and optional additional functional ingredients make up a large amount, or even substantially all of the total weight of the compositions. For example, in some embodiments few or no additional functional ingredients are disposed therein.

In various embodiments, the solid cleaning and degreasing compositions do not include sodium phosphate and/or sodium tripolyphosphate.

In other embodiments, additional functional ingredients may be included in the compositions. The functional ingredients provide desired properties and functionalities to the compositions. For the purpose of this application, the term “functional ingredient” includes a material that when dispersed or dissolved in a use and/or concentrate solution, such as an aqueous solution, provides a beneficial property in a particular use. Some particular examples of functional materials are discussed in more detail below, although the particular materials discussed are given by way of example only, and that a broad variety of other functional ingredients may be used. For example, many of the functional materials discussed below relate to materials used in cleaning. However, other embodiments may include functional ingredients for use in other applications.

In some embodiments, the compositions may include processing aids, additional chelants and/or surfactants, optical brighteners, defoaming agents, anti-redeposition agents, bleaching agents, solubility modifiers, dispersants, metal protecting agents, stabilizing agents, corrosion inhibitors, fillers, aesthetic enhancing agents including fragrances and/or dyes, additional rheology and/or solubility modifiers or thickeners, hydrotropes or couplers, buffers, solvents, additional cleaning agents and the like.

According to embodiments of the disclosure, the various additional functional ingredients may be provided in a composition in the amount from about 0 wt-% and about 40 wt-%, from about 0 wt-% and about 30 wt-%, from about 0 wt-% and about 20 wt-%, from about 0 wt-% and about 15 wt-%, from about 0.01 wt-% and about 15 wt-%, from about 0.1 wt-% and about 15 wt-%, or from about 1 wt-% and about 15 wt-%. In addition, without being limited according to the disclosure, all ranges recited are inclusive of the numbers defining the range and include each integer within the defined range.

### Corrosion Inhibitors

The solid cleaning and degreasing compositions can include an effective amount of a corrosion inhibitor. Exemplary corrosion inhibitors include an alkali metal silicate or hydrate thereof, alkali metal metasilicate or hydrate thereof, alkali metal gluconate, succinate, phosphino succinate, or combination thereof. Exemplary alkali metal silicates include powdered, particulate or granular silicates which are either anhydrous or preferably which contain water of hydration. These silicates include sodium silicates and have a Na₂O: SiO₂ ratio of about 1:1 to about 1:5, respectively.

Additional exemplary corrosion inhibitors include for example, an imidazoline compound, a quaternary ammonium compound, a pyridinium compound, or a combination thereof. Still further exemplary corrosion inhibitors can include for example a phosphate ester, monomeric or oligomeric fatty acid, alkoxylated amine, or mixture thereof. Disclosure of such exemplary corrosion inhibitors are set forth in U.S. Pat. No. 11,155,481, the entire content of which are incorporated by reference herein in its entirety.

In some embodiments of the solid cleaning and degreasing compositions have a corrosion inhibitor present in the amount of between about 0.01 wt-% and about 20 wt-%, between about 0.1 wt-% and about 20 wt-%, or between about 1 wt-% and about 20 wt-%. In addition, without being limited according to the disclosure, all ranges recited are inclusive of the numbers defining the range and include each integer within the defined range.

### Processing Aids and/or Fillers

The solid cleaning and degreasing compositions can include an effective amount of a processing aid and/or filler. Examples of processing aids can include hydroxy-containing compounds such as polyols, polyalkylene glycols, including polyethylene glycol, stearates (e.g. Mg or Na stearate), sorbitan esters, and/or a binder/disintegrating agents.

Polyethylene glycol (also called PEG) refers to a polymer containing ethylene glycol monomer units of formula —O−CH₂—CH₂—. Examples of the polyethylene glycol include PEG1000, PEG1500, PEG2000, PEG2500, PEG3000, PEG3350, PEG3500, PEG4000, PEG5000, PEG6000, PEG8000, and the like.

In some embodiments, the binder/disintegrating agents comprise a polycarboxylic acid polymer or salt or derivative thereof or polycarboxylate polymer, which can also provide chelating benefits. As referred to herein, the reference to any polycarboxylic acid polymer shall further encompass the salt or derivative thereof as also being a suitable polymer for use in the solid cleaning compositions. Examples of particularly suitable polycarboxylic acid polymers include, but are not limited to: polyacrylic acid polymers, polyacrylic acid polymers modified by a fatty acid end group (“modified polyacrylic acid polymers”), polymaleic acid polymers and combinations of these polymer materials. Salts of each of the polycarboxylic acid polymers may further be employed for the solid alkaline detergent compositions.

As referred to herein the polycarboxylic acid polymers or salts or derivatives thereof are not surfactants for the solid compositions. In an embodiment, the solid compositions do not include surfactants while providing efficacious solid stability for the composition and efficacious cleaning.

Non-limiting examples of polycarboxylic acid polymer salts include polyacrylic acid salts and derivatives, such as water soluble acrylic polymers. Such polymers include, but are not limited to, polyacrylic acid, polymethacrylic acid, acrylic acid, acrylic acid-methacrylic acid copolymers, polymaleic acid, hydrolyzed polyacrylamide, hydrolyzed methacrylamide, hydrolyzed acrylamide-methacrylamide copolymers, hydrolyzed polyacrylonitrile, hydrolyzed polymethacrylonitrile, hydrolyzed acrylonitrile methacrylonitrile copolymers, and the like, or combinations thereof or copolymers thereof. Water soluble salts or partial salts of these polymers such as their respective alkali metal (e.g., sodium, potassium, or combinations thereof) or ammonium salts can also be used.

An example of particularly suitable commercially available polyacrylic acid polymer and salts and derivatives thereof includes, but is not limited to, Acusol 445ND, available from Rohm & Haas LLC, Philadelphia, Pa. An example of particularly suitable commercially available modified polyacrylic acid polymer includes, but is not limited to, Alcosperse 325, available from Alco Chemical, Chattanooga, Tenn. Examples of particularly suitable commercially available polymaleic acid polymers include, but are not limited to: Belclene 200, available from Houghton Chemical Corporation, Boston, Mass. and Aquatreat AR-801, available from Alco Chemical, Chattanooga, Tenn.

Examples of particularly suitable polyacrylic acid polymers and modified polyacrylic acid polymers and salts and derivatives thereof, include those having a molecular weight of between about 1,000 and about 100,000 g/mol, preferably between about 1,000 and about 25,000 g/mol. In alternative embodiments, the solid compositions may include at least two polyacrylic acid polymers having different molecular weights.

Phosphonocarboxylic acid copolymer or phosphonopolyacrylic acid homopolymer having the following structure are also suitable polycarboxylic acid polymers:

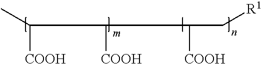

wherein R₁ is a phosphino (—PH(═O)(OH)) or phosphono (—P(═O)(OH)₂) end group. The molecular weight is from about 1,000 to about 50,000 g/mol, and the ratio of min is from about 1:50 to about 2:5. In an embodiment the phosphino or phosphono end group comprises from about 0.1 wt % to about 12 wt % of the polycarboxylic acid copolymer. In certain aspects R₁ is PO₂H₂ or PO₃H₂. In additional aspects, m is an integer of 0 or larger, and n is an integer of 2 or larger. The value of the maleic group (m) of the phosphonocarboxylic acid copolymer or phosphonopolyacrylic acid homopolymer may be zero for the homopolymer. The value of the acrylic group (n) of the phosphonocarboxylic acid copolymer or phosphonopolyacrylic acid homopolymer may be at least 2. In an aspect of the invention for the copolymer, the sum of m+n is between about 5 to 180, wherein the molecular weight range of the polymer is between about 1,000 and 50,000.

As used herein, the term “phosphono end group” refers to a phosphono functional group according to the formula:

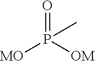

wherein each M is independently H or a cation, preferably both Ms are H.

Any reference to phosphonocarboxylic acid copolymers or phosphonopolyacrylic acid homopolymers shall be understood to equally incorporate and include any phosphonocarboxylic acid copolymers or phosphonopolyacrylic acid homopolymers set forth by the above formula. In some embodiments, polyacrylic phosphono end group polymers or acrylic-maleic phosphono end group copolymers have the following general formula (as depicted above): H₂PO₃—(CH₂—CHCOOH)n(CHCOOH—CHCOOH)m. In some aspects n is an integer greater than 0, m is an integer of 0 (for polyacrylic polymers) or greater (for acrylic-maleic copolymers). For polyacrylates, m is zero. In some aspects n and m are integers independently selected to give a molecular weight of the polymer of between about 500 and 200,000 g/mol, preferably of between 500 and 100,000 g/mol, and more preferably between 1,000 and 25,000 g/mol. In some embodiments, suitable polycarboxylates with phosphono end groups are copolymers of acrylic acid and maleic acid having a phosphono end group and homopolymers of acrylic acid having a phosphono end group. An example of a preferred modified polycarboxylate is a copolymer of acrylic acid and maleic acid with a phosphonic/phosphono end group according to the following general formula:

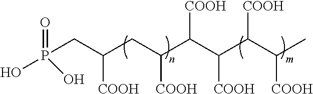

having variable molecular weights, wherein n is from about 10 mol % to 90 mol %, preferably from about 80 mol %, and wherein m is from about 10 mol % to 90 mol %, preferably from about 20 mol %.

Phosphonocarboxylic acid copolymers or phosphonopolyacrylic acid homopolymers are low-phosphorus, non-nitrogenous and environmentally friendly agents that may be synthesized as a combination of various chain-length phosphonocarboxylic acid copolymers or phosphonopolyacrylic acid homopolymers. Phosphonocarboxylic acid copolymers or phosphonopolyacrylic acid homopolymers may have various chain length polymers and therefore varying molecular weights. Examples of suitable commercially-available phosphonocarboxylic acid copolymers include Acusol 425N, available from Rohm & Haas. Acusol 425N is a low molecular weight (1900 MW) acrylic/maleic (ratio 80/20) copolymer having a phosphono end group (approximately 1.6-1.7 wt-% phosphorus) and has an activity of 50%. In some embodiments, a low molecular weight phosphonocarboxylic acid copolymer is preferred, such as polymers having molecular weight below about 2,000 grams/mole.

The polymers, including the phosphorus end group may be present fully or partly in the neutralized form. In some aspects the phosphonocarboxylic acid copolymers or phosphonopolyacrylic acid homopolymers are neutralized.

However, as disclosed herein in various embodiments the additional functional ingredient does not include phosphonates, as some embodiments the composition is free of phosphonates.

In some embodiments of the solid cleaning and degreasing compositions have processing aids and/or fillers present in the amount of between about 0.1 wt-% and about 10 wt-%, between about 0.5 wt-% and about 10 wt-%, or between about 2 wt-% and about 10 wt-%. In addition, without being limited according to the disclosure, all ranges recited are inclusive of the numbers defining the range and include each integer within the defined range.

### Methods of Use

The solid cleaning and degreasing compositions are provided to an application of use, such as an oven or other hard surface, and used to generate an aqueous cleaning composition, e.g., use solution. Typically, the solid composition as disclosed herein dissolves quickly and completely upon contact with aqueous solution into a stable use solution. A stable use solution does not contain any solids upon visual inspection.

In various embodiments, the solid composition is dosed into a wash cycle or dosed into a system in need of extended treatment time, such as an oven or other heavily soiled surface requiring an extended contact time with the cleaning and degreasing composition. A solid composition is provided at a desired “dispense rate”, referring to an amount of the solid mass provided either through a dispensing unit or preferably dosed directly into a system and subjected to water contact through the dispenser's mechanism for a certain period of time. The solid contacts water at a certain temperature and pressure to dissolve into a use solution for cleaning applications.

A variety of dispensers are suitable for dispensing the solid cleaning and degreasing compositions disclosed herein. A dispenser uses a block of a specific dimension and shape and can be configured to deliver water of a certain temperature and pressure. In preferred embodiments, a dispenser is not required for use of the solid cleaning and degreasing compositions. In certain embodiments, a user doses (or provides the solid) directly into a system in need of cleaning and water at a desired temperature and pressure is applied to the solid within the system. For example, a solid cleaning and degreasing composition can be inserted directly into an oven, for example through a funnel, directly into oven's chamber or other member, and a water pump and spray arm thereafter distribute a use solution of the cleaning composition to all surfaces of the oven in need of cleaning.

In other aspects, the solid compositions may be initially used to generate an aqueous solution or suspension for delivery to a hard surface, such as an oven, for cleaning. Thereafter, the use solutions are applied to the internal surfaces of the apparatus, such as for example, through the use of spray nozzles and/or spray jets or the like.

In either embodiment, employing a dispenser or the solid cleaning and degreasing composition placed directly into a system in need of cleaning, a user controls the dispense rate of a solid, e.g. tablet, via the water source and how it is applied (such as through a nozzle and dispense plate) with a certain temperature and pressure. When the water contacts the solid composition it dissolves the components into a use solution. In exemplary applications of use, the solid compositions are contacted by water at a temperature of at least about 90° F., at least about 115° F., or at least about 140° F. may be used. A pressure of at least about 20 psi, at least about 35 psi, or at least about 50 psi for water may also be used, respectively.

In preferred embodiments, the range for water temperature is typically from about 50° F. to about 160° F., and the range for water pressure from about 20 psi to about 100 psi; preferably with temperatures about 90° F. to about 140° F. and water pressures from about 20 psi to about 60 psi. Various types of water can be used. In some aspects city or municipal water with 0, 5, 17, or higher grains per gallon (gpg) is employed.

A concentrated use solution is preferably employed in the methods of cleaning. In an aspect, a use solution of the solid cleaning and degreasing composition provides at least about 0.1% to about 10%, or preferably from about 0.1% to about 5% use concentration to a surface in need of cleaning.

In some embodiments a concentrated use solution of between about 500 ppm and about 50,000 ppm hydroxide alkalinity. In other embodiments, a concentrated use solution of between about 1,000 ppm and about 100,000 ppm total actives, or about 1,000 ppm and about 50,000 ppm total actives.

In some embodiments wherein a solid tablet has a size of between about 1 gram and about 250 grams, namely from about 30 grams to about 100 grams, and in various embodiments 1-2 tablets are dosed to a surface or equipment in need of cleaning to generate a use solution.

The generated use solution from the solid compositions provides efficient removal of soils from a surface, e.g., a hard surface. In some embodiments, the method comprises contacting a use solution from the solid composition with a surface, and removing the composition from the surface after an amount of time sufficient to facilitate soil removal. The contacting step can last for any suitable time. In some embodiments, the contacting step lasts for at least 30 minutes, 1 hour, 2 hours, 3 hours, 4 hours, 5 hours, or longer, and in some embodiments the contacting step lasts for between about 30 minutes and about 3 hours.

The cleaning and degreasing composition can contact the surface (or target for soil removal) in any suitable manner. In some embodiments, the cleaning and degreasing composition is applied by means of a spray, a foam, soaking or the like. In preferred embodiments, the cleaning and degreasing composition does not employ a dispenser. In preferred embodiments, the solid cleaning and degreasing composition can be placed directly onto or into the hard surface. Thereafter, a water source, such as a hot water source, is applied to dissolve the solid cleaning and degreasing composition and generate the concentrated use solution. Beneficially, the use solution provides high concentration alkalinity source for hydrolyzing the soils, namely fatty and/or greasy soils and the chelant and surfactant further aid in soil removal.

The methods can be used to achieve any suitable removal of soil (e.g. cleaning), and/or reduction of the microbial population in and/or on the surface or target. The methods are beneficially effective in removing fatty and/or greasy soils found in ovens. In particular, the methods are beneficially effective in removing chicken and other animal fat soils found in ovens.

In some embodiments, the methods of cleaning further comprise draining the use solution with hydrolyzed fatty and greasy soils from the hard surface (e.g. oven). The methods of cleaning can further comprise rinsing the surface.

In some embodiments, the method further comprise a mechanical application of force, agitation and/or pressure to assist in removing the soils from the surface and/or ensuring complete contact of the surface with the use solution of the solid cleaning composition.

In some embodiments, the methods are followed by only a rinse step. In other embodiments, the methods are followed by a conventional CIP method suitable for the surface to be cleaned. In still yet other embodiments, the methods are followed by a CIP method such as those described in U.S. Pat. Nos. 8,398,781 and 8,114,222 entitled “Methods for Cleaning Industrial Equipment with Pre-treatment,” both of which are hereby incorporated by reference in their entirety.

The methods can be used to remove a variety of soils from a variety of surfaces. For example, surfaces suitable for cleaning using the methods include, but are not limited to, hard surfaces, including ovens. Ovens can include self-cleaning ovens (e.g. rotisserie style) or combination ovens, such as those used in various food service industries. Various ovens are disclosed, for example, in U.S. Pat. Nos. 5,368,008, 5,640,946, and 6,410,890, EP 0652405 and DE 2842771, which are herein incorporated by references in their entirety.

Additional surfaces that can be treated according to the methods described may include fryers, smoke houses, sewer drain lines, walls, floors, ware, dishes, flatware, pots and pans, heat exchange coils, and the like. Applications requiring a presoak or an extending soak for soil removal are particularly well suited for use of the solid cleaning compositions. In a preferred embodiment, the surface to be treated is self-contained to hold a volume of the use solution and allows the soaking for an extended period of time of the use solution of the solid cleaning composition.

In an embodiment, the solid cleaning and degreasing compositions provide complete soil removal from the hard surface. In an aspect, at least about 70% soil removal, at least about 80% soil removal, at least about 85% soil removal, or at least about 90% soil removal is achieved according to the methods employing the solid compositions.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

### Example 1

Cleaning performance of solid cleaning and degreasing compositions was evaluated to assess efficacy based on variations in alkalinity sources employed in the composition. For each test a 3% solution was prepared from the formulations shown in Table 2.

TABLE 2

| Component (wt-%) | Trial 1 | Trial 2 |
|---|---|---|
| Sodium carbonate | 30-40 | 15-25 |
| Sodium hydroxide | 25-35 | 40-50 |
| Sodium metasilicate | 10-15 | 10-15 |
| Sodium gluconate | 12-15 | 12-15 |
| PEG 6000 | 4 | 4 |
| Sodium polyacrylate | 5 | 4 |
| Mg Stearate | <1 | <1 |

Soiled metal coupons were with oil, starch, protein and grease and heated to 200° C. for 15 minutes to create a challenging to remove soil. These were evaluated using Trial 1 and 2 formulations described in Example 1. The coupons were submerged in the compositions for 30 minutes at 60° C. according to oven washing processes.

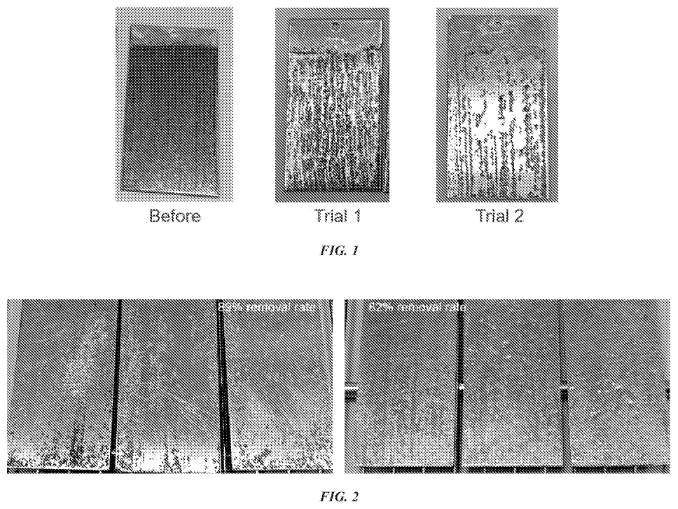

Images were taken by photograph showing that increasing alkalinity in Trial 2 improved soil removal as shown in FIG. 1, as assessed by visual measurement.

### Example 2

Further formulation modifications were made to compare an embodiment of the solid cleaning and degreasing compositions to a competitive commercial product as shown in Table 3. The same testing methodology were used as described in Example 1.

TABLE 3

| Component (wt-%) | Trial 3 | Commercial Formulation |
|---|---|---|
| Sodium carbonate | 10-20 | 15-20 |
| Sodium hydroxide | 60-70 | 40-45 |
| Sodium metasilicate | 5-10 | 15-20 |
| Corrosion inhibitor | 0.5-5 | 5-10 |
| Surfactant | 0.5-5 | 0 |
| Chelant | 2-10 | 0 |
| Processing Aid | 4-12 | 0 |
| Mg Stearate | <1 | <1 |

The results are shown in FIG. 2, where images taken by photograph show that increased alkalinity and inclusion of the alkali metal unsaturated fatty acid salt surfactant provide improved cleaning. The three coupons on the left show an 89% soil removal rate compared to the three coupons on the right having only an 82% soil removal rate. The results were quantified by weighing soil coupons before and after cleaning (compared to coupon weight without any soil) and then soil removal percentage was calculated according to the formula: (weight of cleaned coupon-coupon without soil)/(weight of soiled coupon-coupon without soil).

### Example 3

A commercially-available oven-cleaning product was evaluated in a submersion test in a 1000 ml beaker. The oven-cleaning product contains sodium hydroxide and a silicate salt. Upon dissolution and soaking to evaluate cleaning efficacy, there remains a significant amount of undissolved lubricants, e.g. silica or talc, from the composition that created a sediment at the bottom of the beaker. As a result, there is an undesirable film left on the treated surface. It is highly undesirable to have films and sediments remaining after cleaning a surface.

A comparison formulation as shown in Table 4 did not result in any films and/or undissolved solid sediments in a beaker soaking test.

TABLE 4

| Material | wt.-% |
|---|---|
| Alkali metal alkalinity source(s) sodium hydroxide, | 80-90 |
| sodium metasilicate, and sodium carbonate | |
| Chelant | 1-4 |
| Surfactant | 1-4 |
| Processing Aids | 2-20 |

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. All publications discussed and/or referenced herein are incorporated herein in their entirety.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

1. A solid cleaning composition comprising:
(a) at least two alkali metal alkalinity sources comprising an alkali metal hydroxide, alkali metal carbonate, alkali metal metasilicate, or combinations thereof;
(b) a chelant comprising an aminocarboxylic acid or salt thereof; and
(c) a surfactant comprising a salt of fatty acid, alkyl sulfate, alkyl ether sulfonate, alkyl aryl sulfonate, alkyl benzene sulfonate, alkyl polyglucoside, fatty alcohol polyether, or combination thereof.

2. The composition of claim 1, comprising from about 50-90 wt-% of the at least two alkali metal alkalinity sources, from about 1-10 wt-% of the at least one chelant, and from about 0.5-5 wt-% of the surfactant.

3. The composition of claim 1, wherein the at least two alkali metal alkalinity sources are an alkali metal hydroxide, an alkali metal carbonate, and an alkali metal metasilicate, wherein the alkali metal hydroxide comprises from about 40-80 wt-% of the composition, the alkali metal carbonate comprises from about 5-20 wt-% of the composition, and the alkali metal metasilicate comprises from about 5-20 wt-% of the composition.

4. The composition of claim 1, wherein the chelant is an aminocarboxylic acid salt comprising salts of methylglycinediacetic acid (MGDA), N-hydroxyethyliminodiacetic acid, ethylenediaminetetraacetic acid (EDTA), N-hydroxyethyl-ethylenediaminetriacetic acid (HEDTA), diethylenetriaminepentaacetic acid (DTPA), ethylenediaminetetraproprionic acid triethylenetetraaminehexaacetic acid, or combinations thereof.

5. The composition of claim 1, wherein the surfactant is an alkali metal unsaturated fatty acid salt.

6. The composition of claim 1, wherein the surfactant has a C9-C20 carbon chain that can be linear or branched, and wherein the fatty alcohol polyether surfactant has 3 to 8 moles of ethylene oxide.

7. The composition of claim 1, wherein the surfactant is a sodium dodecylbenzene sulfonate, sodium dodecyl sulfate, sodium lauryl sulfate, sodium myristate sulfate, sodium alpha-olefin sulfonate, sodium palmitate, palmitoleic acid sodium salt, sodium myristate, sodium laurate, linoleic acid sodium salt, tetradecenoic acid sodium salt, lauroleic acid sodium salt, sodium oleate, C8-C10 polyglucoside, C12-C14 polyglucoside, fatty alcohol polyether, or combination thereof.

8. The composition of claim 1, further comprising from about 0.01-10 wt-% of a corrosion inhibitor.

9. The composition of claim 8, wherein the corrosion inhibitor is an alkali metal silicate, an alkali metal metasilicate, an alkali metal gluconate, or combination thereof.

10. The composition of claim 1, further comprising from about 0.5-20 wt-% of a processing aid and/or filler.

11. The composition of claim 10, wherein the processing aid comprises polyethylene glycol, Mg or Na stearate, and/or a binder/disintegrating agent comprising a polycarboxylic acid polymer or salt thereof or polycarboxylate polymer.

12. The composition of claim 11, wherein the polycarboxylic acid polymer or salt thereof or polycarboxylate polymer has a molecular weight between about 1,000 and about 25,000 g/mol, or the composition includes a combination of polyacrylic acid polymer or salt thereof or polycarboxylate polymer having distinct molecular weights between about 1,000 and about 25,000 g/mol.

13. The composition of claim 1, wherein the composition is free of phosphonates and/or additional surfactants.

14. The composition of claim 1, wherein the solid is a pressed solid.

15. The composition of claim 1, wherein the solid is a tablet composition having a weight between about 1 gram to about 100 grams.

16. A method of cleaning a hard surface comprising:
generating a use solution of the solid cleaning composition of claim 1;
providing the use solution to a hard surface or object in need of cleaning; and
cleaning soils from the hard surface or object.

17. The method of claim 16, further comprising rinsing the hard surface or object after cleaning the soils with the use solution of the solid cleaning composition.

18. The method of claim 16, where the pH of the use solution is between about 10 and about 13.5.

19. The method of claim 16, wherein the hard surface is metal.

20. The method of claim 16, wherein the soils removed include carbonized, greasy and/or fatty soils.
